(19) United States
(12) Patent Application Publication
(10) Pub. No.: US 2020/0191269 A1
(43) Pub. Date: Jun. 18, 2020

(54) PISTON RING, PISTON ASSEMBLY INCLUDING PISTON RING, AND METHODS OF MANUFACTURING

(71) Applicant: TENNECO INC., Lake Forest, IL (US)

(72) Inventor: Ronald Nelson Radunzel, Rockford, MI (US)

(21) Appl. No.: 16/220,989

(22) Filed: Dec. 14, 2018

(51) Int. Cl. F16J 9/08

(52) U.S. Cl. CPC F16J 9/08

(57) ABSTRACT

An oil ring for a piston of an internal combustion engine is provided. The oil ring is disposed in a ring groove of the piston and includes a counterbore along an inner diameter surface. A land in the piston which is located above the ring groove containing the oil ring includes a plurality of holes extending radially inwardly to the ring groove behind the counterbore of the oil ring. During operation, the oil ring will be energized during the power stroke by channeling combustion pressure from the piston land above the oil ring through the holes and to the area in the ring groove behind the oil ring. The oil ring is not energized during the remaining strokes, which results in a reduction of oil ring friction while still maintaining oil film control.

### BACKGROUND OF THE INVENTION

### 1. Field of the Invention

The present invention is related generally to piston rings, piston assemblies including piston rings, and methods of manufacturing the same.

### 2. Related Art

Internal combustion engine manufacturers are encountering increasing demands to improve engine efficiencies and performance, including, but not limited to, improving fuel economy, improving fuel combustion, reducing oil consumption, increasing the exhaust temperature for subsequent use of the heat, increasing compression loads within the cylinder bores, decreasing weight and making engines more compact. In order to satisfy one or more of these demands, many engine manufacturers have been employing advanced technologies to increase the temperature and pressure loads within the combustion chambers of their engines. Consequently, such pistons must be sealed to their respective cylinder bores with piston rings that are designed to withstand the increasingly extreme environment.

Most pistons are sealed against their respective cylinder walls with three piston rings which are axially spaced from one another, and each piston ring is optimized to perform a specific task. Traditionally, the top ring is a compression ring optimized for sealing combustion gasses in the combustion chamber above the piston. The bottom ring is typically an oil control ring which is optimized for scraping the cylinder wall and keeping oil from passing into the combustion chamber. The second, or intermediate, ring typically serves the dual purposes of assisting the top compression ring in sealing the combustion gasses in the combustion chamber and also scraping any oil that made it past the oil control ring.

### SUMMARY

One aspect of the present invention provides an oil ring for a piston of an internal combustion engine capable of reducing friction while maintaining good control of an oil film along a cylinder during operation in the engine. The oil ring comprises a ring body extending circumferentially around a center axis between opposite ends. The ring body presents an outer diameter surface and an inner diameter surface spaced from one another by a top surface and a bottom surface. The piston body includes an inner land extending radially from the bottom surface toward the center axis and forming a portion of the inner diameter surface. The inner diameter surface presents a counterbore between the inner land and the top surface of the ring body. The ring body includes an outer lower land extending radially outwardly from the bottom surface and away from the center axis and an outer upper land extending radially outwardly from the top surface and away from the center axis. The outer lower land and the outer upper land present a portion of the outer diameter surface. The outer diameter surface presents an oil groove between the outer lower land and the outer upper land.

Another aspect of the invention provides a piston assembly including a piston and oil ring capable of reducing friction while maintaining good control of an oil film along a cylinder during operation in the engine. The piston comprises a piston body including a combustion surface and a ring belt depending from the combustion surface and extending circumferentially around a center axis. The ring belt includes a plurality of ring grooves spaced from one another by piston lands. The oil ring is disposed in one of the ring grooves. One of the piston lands which is located above the one ring groove containing the oil ring includes a plurality of holes. The holes extend radially inwardly to the ring groove containing the oil ring. The oil ring includes a ring body extending circumferentially around the center axis between opposite ends. The ring body presents an outer diameter surface and an inner diameter surface spaced from one another by a top surface and a bottom surface. The ring body includes an inner land extending radially from the bottom surface toward the center axis and forming a portion of the inner diameter surface; and the ring body includes a counterbore between the inner land and the top surface of the ring body.

Another aspect of the invention provides a method of manufacturing the oil ring. The method includes providing a ring body extending circumferentially around a center axis between opposite ends. The ring body presents an outer diameter surface and an inner diameter surface spaced from one another by a top surface and a bottom surface. The ring body includes an inner land extending radially from the bottom surface toward the center axis and forming a portion of the inner diameter surface. The inner diameter surface presents a counterbore between the inner land and the top surface of the ring body. The ring body includes an outer lower land extending radially outwardly from the bottom surface and away from the center axis and an outer upper land extending radially outwardly from the top surface and away from the center axis. The outer lower land and the outer upper land present a portion of the outer diameter surface. The outer diameter surface presents an oil groove between the outer lower land and the outer upper land.

Yet another aspect of the invention provides a method of manufacturing a piston assembly, comprising the steps of: providing a piston body including a combustion surface and a ring belt depending from the combustion surface and extending circumferentially around a center axis, the ring belt including a plurality of ring grooves spaced from one another by lands; and disposing an oil ring in one of the ring grooves of the piston body, wherein one of the lands which is located above the one ring groove containing the oil ring including a plurality of holes, and the holes extending radially inwardly to the ring groove containing the oil ring. The oil ring includes a ring body extending circumferentially around the center axis between opposite ends. The ring body presents an outer diameter surface and an inner diameter surface spaced from one another by a top surface and a bottom surface. The ring body includes an inner land extending radially from the bottom surface toward the center axis and forming a portion of the inner diameter surface, and the ring body includes a counterbore between the inner land and the top surface of the ring body.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a top view of an oil ring according to an example embodiment;

FIG. 2 is a cross-sectional view of a piston assembly including an oil ring disposed in an internal combustion engine according to an example embodiment;

FIG. 3 is an enlarged cross-sectional view of a portion of the oil ring disposed in a ring groove of the piston according to an example embodiment;

FIG. 4 is another enlarged cross-sectional view of the portion of the oil ring disposed in the ring groove of the piston of FIG. 3 showing the flow of combustion gases and oil during a power stroke; and

FIG. 5 is another enlarged cross-sectional view of the portion of the oil ring disposed in the ring groove of the piston of FIG. 3 showing the flow oil during compression and exhaust strokes.

### DESCRIPTION OF EXEMPLARY EMBODIMENTS

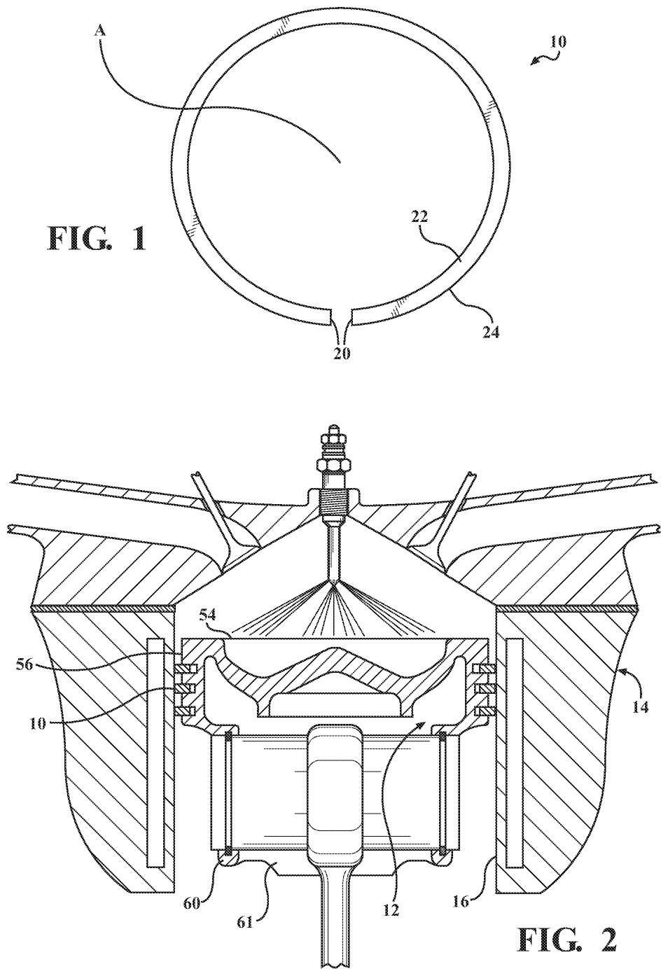

As shown in FIGS. 1 and 2, the invention provides an oil ring 10 for a piston 12 of an internal combustion engine 14 which is capable of reducing tension and thus friction of the oil ring against a cylinder 16 while maintaining good control of an oil film along the cylinder during operation of the piston in the engine.

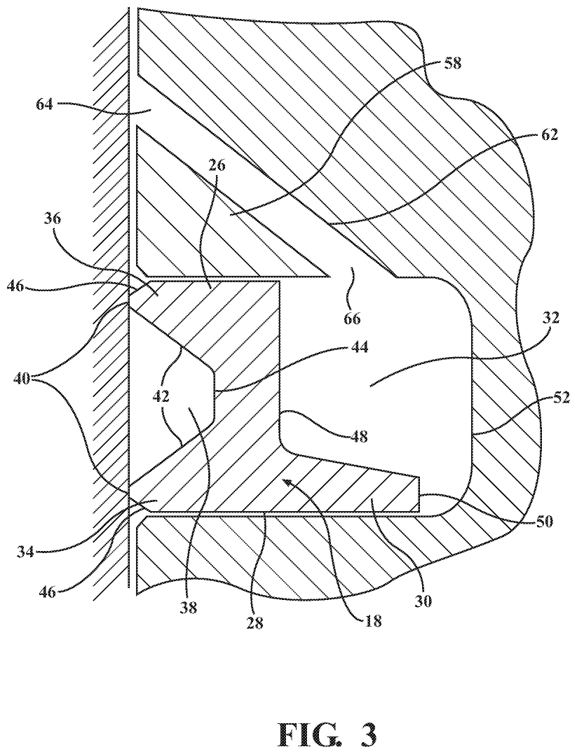

The oil ring comprises a ring body 18 extending circumferentially around a center axis A between opposite ends 20. The ring body of the oil ring is formed of metal, such as steel or aluminum, and the ring body is free of holes for draining oil. As shown in FIGS. 3-5, the ring body presents an outer diameter surface 22 and an inner diameter surface 24 spaced from one another by a top surface 26 and a bottom surface 28. The ring body includes an inner land 30 extending radially from the bottom surface toward the center axis and forming a portion of the inner diameter surface. The inner diameter surface presents a counterbore 32 between the inner land and the top surface of the ring body. The ring body also includes an outer lower land 34 extending radially outwardly from the bottom surface and away from the center axis and an outer upper land 36 extending radially outwardly from the top surface and away from the center axis. The outer lower land and the outer upper land present a portion of the outer diameter surface. The outer diameter surface presents an oil groove 38 between the outer lower land and the outer upper land. According to one embodiment, the outer diameter surface along the outer lower land of the ring body includes a plurality of scallops.

Also shown in FIGS. 3-5, the outer diameter surface of the ring body includes outer flat areas 40 at outermost points of the outer lands and inner areas 42 extending radially toward the center axis and toward one another at an angle from the outer flat areas to a base 44 of the outer diameter groove. The outer diameter surface of the ring body also includes outer areas 46 extending radially toward the center axis and away from one another at an angle from the outer flat areas to the top surface and the bottom surface of the ring body. The oil groove has a depth extending perpendicular to the center axis of 0.80 mm to 1.2 mm. This depth is measure from the outermost points of the outer lands to the base of the oil groove. The oil groove is preferably made as deep as possible without an undesirable loss of function of the oil ring.

The inner diameter surface of the oil ring includes a first inner flat area 48 extending from the top surface to the inner land. The inner diameter surface then extends radially inwardly along the inner land toward the center axis and at an angle from the first inner flat area to a second inner flat area 50 which presents an innermost point of the ring body. The second inner flat area extends to the bottom surface of the ring body.

As shown in FIG. 2, the oil ring is disposed in a ring groove 52 of the piston to form a piston assembly, and the piston assembly is disposed in a combustion chamber of the internal combustion engine. The piston typically includes a plurality of the ring grooves for containing the oil ring and other types of piston rings, such as two or three ring grooves. According to one embodiment, the piston includes two ring grooves, and no more than two ring grooves, including a first ring groove and second ring groove, which is further from the combustion surface than the first ring grove. The oil ring is disposed in the second ring groove. When the oil ring is disposed in the second ring groove, a zero tension dykes (ZOT) ring can be disposed in the first ring groove, and the oil ring is able to significantly reduce the tension and, in turn, the friction of the oil ring against the cylinder. According to another embodiment, the piston includes three ring grooves, wherein the third ring groove is further from the combustion surface than the second ring groove, and the oil ring is disposed in the second ring groove. Alternatively, the oil ring can be the only piston ring used in the piston assembly.

As shown in FIG. 2, the piston body includes a combustion surface 54 and a ring belt 56 depending from the combustion surface and extending circumferentially around the center axis. The ring belt includes the plurality of the ring grooves spaced from one another by piston lands 58. The oil ring is disposed in one of the ring grooves. The piston body is formed of a metal material, such as a steel or aluminum material. The piston body also includes a pair of pin bosses 60 depending from the ring belt and spaced from one another by pair of skirt sections 61 depending from said ring belt.

As best shown in FIGS. 3-5, one of the piston lands which is located above the one ring groove containing the oil ring includes a plurality of holes 62. The holes extend radially inwardly and downwardly to the ring groove containing the oil ring. The holes in the one piston land of the piston body containing the oil ring include openings 64, 66 located radially inwardly of the counterbore of the ring body and are in communication with the ring groove. More specifically, the piston lands present the outermost surface of the piston body, the holes in the one land containing the oil ring extending radially inwardly at an angle from a first opening 64 located at the outermost surface of the piston body to a second opening 66 located radially inwardly of the counterbore of the ring body of the oil ring and in fluid communication with the ring groove.

The piston ring and piston assembly have several advantages during operation in the internal combustion engine. During operation, the oil ring will be energized during the power stroke by channeling combustion pressure from the piston land above the oil ring to the area in the ring groove behind the oil ring. The pressure will pass through the series of holes placed around the piston land to the back of the oil ring groove. The same results may be obtained by suitably dimensioning the piston land and ring groove geometry and clearances, as those skilled in the art will recognize. The oil ring is not energized during the remaining strokes, which results in a reduction of oil ring friction while still maintaining oil film control.

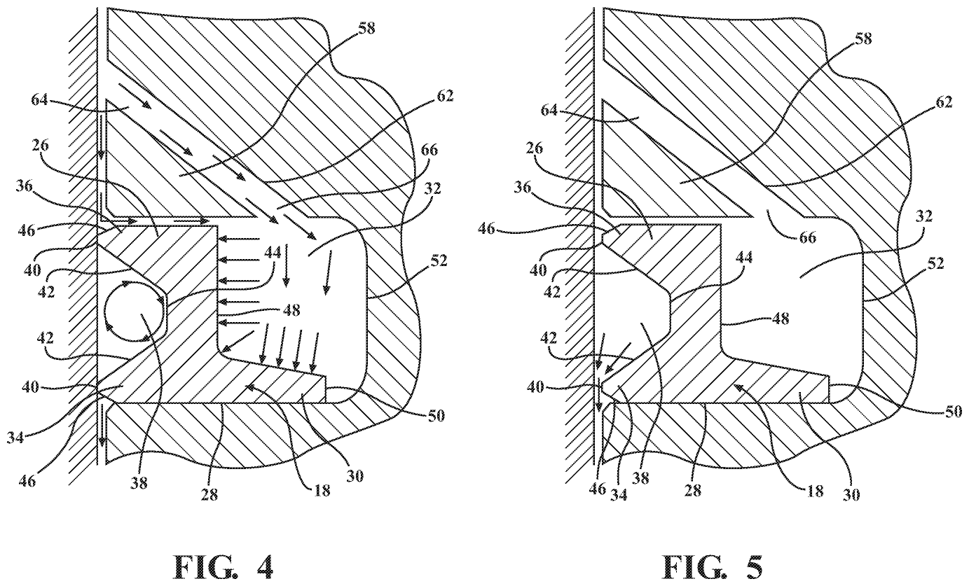

The features of the counterbore on the top inner diameter corner of the cross-section of the oil ring, combined with no oil drain slots or holes in the oil ring, allow the combustion pressure from the piston land above to build behind the oil ring during the power stroke. The pressure will apply forces to the inner diameter surface or profile of the oil ring, pushing the oil ring against the bottom of the ring groove and to the cylinder thus sealing oil from moving upward past the oil ring. The oil ring has a very low tangential force because the free gap is minimized and there is no coil spring or expander to supply external force. The friction will be greatly reduced during the intake, compression, and exhaust strokes. The outer lands of the oil ring are spaced far enough apart to allow for the wide, deep outer diameter groove that will accumulate oil scraped by the outer upper land of the oil ring. The scraped oil should be effectively drained. Thus, the spacing of the outer lands on the oil ring, along with the low ring tangential tension and the hydrodynamic forces, will increase the oil film thickness between the outer lands of the oil ring and the cylinder bore on the compression and exhaust strokes. This, along with suitable piston features, will allow oil accumulated in the outer diameter groove of the oil ring to exit below the oil ring. Another option to drain oil from the outer diameter groove of the oil ring is to include the scallops cutout through the outer would be to add scallop cutouts through the outer lower land of the oil ring. FIG. 4 shows the flow of combustion gases and oil during a power stroke; and FIG. 5 shows the flow oil during compression and exhaust strokes.

The piston assembly does not include a coil ring or expander. Thus, the oil seal is maintained by the combustion pressure alone. In addition, since there are no oil drain slots or holes in the oil ring, the combustion pressure behind the ring is sealed. The oil ring alone has little or no tangential force. The outer diameter groove of the oil ring is deep and wide enough to accumulate greater quantities of oil.

Another aspect of the invention provides a method of manufacturing the piston ring and the piston assembly including the piston and piston ring. The method of manufacturing the piston ring can include forming the ring body by casting, forging, machining, and/or other methods known in the art. The method of manufacturing the piston for the piston assembly includes providing the piston body including the combustion surface and the ring belt depending from the combustion surface and extending circumferentially around the center axis, wherein the ring belt includes a plurality of the ring grooves spaced from one another by the lands, and disposing the oil ring in one of the ring grooves of the piston body, wherein one of the lands which is located above the one ring groove containing the oil ring includes a plurality of holes, and the holes extend radially inwardly to the ring groove containing the oil ring. The piston can also be formed by casting, forging, machining, and/or other methods known in the art.

Obviously, many modifications and variations of the present invention are possible in light of the above teachings and may be practiced otherwise than as specifically described while within the scope of the claims. It is contemplated that all features described and of all embodiments can be combined with each other, so long as such combinations would not contradict one another.

What is claimed is:

1. An oil ring, comprising:
a ring body extending circumferentially around a center axis between opposite ends,
said ring body presenting an outer diameter surface and an inner diameter surface spaced from one another by a top surface and a bottom surface,
said ring body including an inner land extending radially from said bottom surface toward said center axis and forming a portion of said inner diameter surface;
said inner diameter surface presenting a counterbore between said inner land and said top surface of said ring body,
said ring body including an outer lower land extending radially outwardly from said bottom surface and away from said center axis and an outer upper land extending radially outwardly from said top surface and away from said center axis;
said outer lower land and said outer upper land presenting a portion of said outer diameter surface; and
said outer diameter surface presenting an oil groove between said outer lower land and said outer upper land.

2. The oil ring of claim 1, wherein said outer diameter surface of said ring body includes outer flat areas at outermost points of said outer lands, said outer diameter surface includes inner areas extending radially toward said center axis and toward one another at an angle from said outer flat areas to a base of said outer diameter groove; and said outer diameter surface of said ring body includes outer areas extending radially toward said center axis and away from one another at an angle from said outer flat areas to said top surface and said bottom surface of said ring body.

3. The oil ring of claim 1, wherein said inner diameter surface includes a first inner flat area extending from said top surface to said inner land, said inner diameter surface extends radially inwardly along said inner land toward said center axis and at an angle from said first inner flat area to a second inner flat area which presents an innermost point of said ring body, said second inner flat area extends to said bottom surface of said ring body.

4. The oil ring of claim 1, wherein said ring body is formed of a metal material and is free of holes for draining oil.

5. The oil ring of claim 1, wherein said oil groove of said outer diameter surface has a depth extending perpendicular to said center axis of 0.80 mm to 1.2 mm.

6. The oil ring of claim 1, wherein said outer diameter surface along said outer lower land of said ring body includes a plurality of scallops.

7. A piston assembly, comprising:
a piston body including a combustion surface and a ring belt depending from said combustion surface and extending circumferentially around a center axis;
said ring belt including a plurality of ring grooves spaced from one another by piston lands;
an oil ring disposed in one of said ring grooves;
one of said piston lands which is located above said one ring groove containing said oil ring including a plurality of holes;
said holes extending radially inwardly to said ring groove containing said oil ring;
said oil ring including a ring body extending circumferentially around said center axis between opposite ends;
said ring body presenting an outer diameter surface and an inner diameter surface spaced from one another by a top surface and a bottom surface;
said ring body including an inner land extending radially from said bottom surface toward said center axis and forming a portion of said inner diameter surface; and
said ring body including a counterbore between said inner land and said top surface of said ring body.

8. The piston assembly of claim 7, wherein said holes in said one piston land of said piston body containing said oil ring include openings located radially inwardly of said counterbore of said ring body and being in fluid communication with said ring groove.

9. The piston assembly of claim 7, wherein said piston lands present an outermost surface of said piston body, said holes in said one land containing said oil ring extending radially inwardly at an angle from a first opening located at said outermost surface of said piston body to a second opening located radially inwardly of said counterbore of said ring body and in fluid communication with said ring groove.

10. The piston assembly of claim 7, wherein said ring body includes an outer lower land extending radially outwardly from said bottom surface and away from said center axis and an outer upper land extending radially outwardly from said top surface and away from said center axis, said outer lower land and said outer upper land presents a portion of said outer diameter surface, and said outer diameter surface includes an outer diameter groove between said outer lower land and said outer upper land

11. The piston assembly of claim 7, wherein said piston body is formed of a metal material, said piston body includes a pair of pin bosses depending from said ring belt and spaced from one another by pair of skirt sections depending from said ring belt, and said ring body is formed of a metal material.

12. The piston assembly of claim 7, wherein said piston body includes two of said ring grooves including a first ring groove and a second ring groove located farther from said combustion surface than said first ring groove, and said oil ring is disposed in said second ring groove.

13. The piston assembly of claim 12, wherein said ring belt includes no more than two of said ring groves.

14. The piston assembly of claim 12, wherein said ring body includes three of said ring grooves including a third ring groove located further from said combustion surface than said second ring groove.

15. The piston assembly of claim 7, wherein said outer diameter surface of said ring body includes outer flat areas at outermost points of said outer lands, said outer diameter surface includes inner areas extending radially toward said center axis and toward one another at an angle from said outer flat areas to a base of said outer diameter groove, said outer diameter surface of said ring body includes outer areas extending radially toward said center axis and away from one another at an angle from said outer flat areas to said top surface and said bottom surface of said ring body, said inner diameter surface includes a first inner flat area extending from said top surface to said inner land, said inner diameter surface extends radially inwardly along said inner land toward said center axis and at an angle from said first inner flat area to a second inner flat area which presents an innermost point of said ring body, and said second inner flat area extends to said bottom surface of said ring body.

16. The piston assembly of claim 7, wherein said ring body is formed of a metal material and is free of oil drain holes.

17. The piston assembly of claim 7, wherein said oil groove of said outer diameter surface of said ring body has a depth extending perpendicular to said center axis of 0.80 mm to 1.2 mm.

18. The piston assembly of claim 7, wherein said outer diameter surface along said outer lower land of said ring body includes a plurality of scallops.

19. A method of manufacturing an oil ring, comprising the steps of:
providing a ring body extending circumferentially around a center axis between opposite ends, the ring body presenting an outer diameter surface and an inner diameter surface spaced from one another by a top surface and a bottom surface, the ring body including an inner land extending radially from the bottom surface toward the center axis and forming a portion of the inner diameter surface, the inner diameter surface presenting a counterbore between the inner land and the top surface of the ring body, the ring body including an outer lower land extending radially outwardly from the bottom surface and away from the center axis and an outer upper land extending radially outwardly from the top surface and away from the center axis, the outer lower land and the outer upper land presenting a portion of the outer diameter surface, and the outer diameter surface presenting an oil groove between the outer lower land and the outer upper land.

20. A method of manufacturing a piston assembly, comprising the steps of:
providing a piston body including a combustion surface and a ring belt depending from the combustion surface and extending circumferentially around a center axis, the ring belt including a plurality of ring grooves spaced from one another by lands;
disposing an oil ring in one of the ring grooves of the piston body, wherein one of the lands which is located above the one ring groove containing the oil ring including a plurality of holes, and the holes extending radially inwardly to the ring groove containing the oil ring;
the oil ring including a ring body extending circumferentially around the center axis between opposite ends, the ring body presenting an outer diameter surface and an inner diameter surface spaced from one another by a top surface and a bottom surface, the ring body including an inner land extending radially from the bottom surface toward the center axis and forming a portion of the inner diameter surface, and the ring body including a counterbore between the inner land and the top surface of the ring body.
